(19) United States
(12) Patent Application Publication
(10) Pub. No.: US 2002/0056413 A1
(43) Pub. Date: May 16, 2002

(54) Chemical solution coating apparatus

(76) Inventors: Kuei-Hsi Lai, Hsinchu Hsien (TW); En-Tien Tan, Hsinchu (TW); Cha-Ming Kuo, Chilung (TW); Jen-Shun Shih, Hualien (TW)

Correspondence Address: CHARLES C.H. WU & ASSOCIATES, 7700 IRVINE CENTER DRIVE Suite 710, Irvine, CA, 92618-3043, US

(21) Appl. No.: 09/728,678

(22) Filed: Dec. 1, 2000

(30) Foreign Application Priority Data
Nov. 15, 2000 (TW) 89219765

(51) Int. Cl. B05C 5/00

(52) U.S. Cl. 118/315; 118/313

(57) ABSTRACT

A chemical solution coating apparatus, having a carrier board and a plurality of spray apparatuses. The carrier board is to carry the wafer to be coated, and the spray apparatuses are located at a periphery of the carrier board to evenly spray chemical solution on the wafer. Since the chemical solution is coated on the wafer in a spray manner, so that the unnecessary lapse and process cost are avoided. The number and spraying angle spray apparatuses can be adjusted to reach an optimum status.

### CROSS-REFERENCE TO RELATED APPLICATION

This application claims the priority benefit of Taiwan application serial no. 89219765, filed Nov. 15, 2000.

### BACKGROUND OF THIS INVENTION

1. Field of the Invention

This invention relates to a chemical solution coating apparatus, and more particularly, to a chemical solution coating apparatus to spray the chemical solution on a target surface.

2. Description of Related Prior Art

FIG. 1 shows a conventional chemical solution coating apparatus. The chemical solution coating apparatus comprises a spin dish 10 and a chemical solution supplier tube 14. As shown in FIG. 1, before operation, a wafer 12 to be coated is fixed on the spin dish 10. The supplier tube 14 then provides photoresist solution 16 to flow on the wafer 12. The spin dish 10 starts spinning to spread the photoresist solution 16 on the wafer under the influence of the spinning force. The photoresist solution 16 is then coated on the wafer 12 to form a thin film.

When the spin dish 12 is spinning with a high speed, most of the photoresist solution (about 98%) will be spread out of the wafer as shown in FIG. 1. As a result, only a small amount of the photoresist solution 16 remains on the wafer 12 to form the thin film. It thus causes a great waste in material, and consequently, the fabrication cost cannot be reduced. Furthermore, it is difficult to process the remaining photoresist solution, and the pollution is inevitable.

### SUMMARY OF THIS INVENTION

This invention provides a chemical solution coating apparatus. The apparatus using a spray method for coating instead of spreading the chemical solution by a centrifugal force. Therefore, the waste in material is reduced since most of the chemical solution can be coated on the target surface. As a consequence, the fabrication cost and the probability of pollution can be significantly reduced.

The chemical solution coating apparatus provided by the invention comprises a carrier board and a plurality of spray apparatuses. The carrier board is used to carry a wafer, and the spray apparatuses are located around the carrier board. Using the spray manner, the chemical solution is supplied on the wafer from the spray apparatuses. The wafer can thus receive the chemical solution uniformly everywhere.

Each of the spray apparatuses uses a high air pressure (for example, nitrogen pressure) to spray the chemical solution. The chemical solution includes, for example, photoresist solution. Since the invention adapts a spray method to provide the chemical solution, as long as the number and spray angle of the spray apparatuses are controlled, the chemical solution can be concentrated on the wafer without being spread out of the wafer. The problems of waste in material and the high processing cost can be resolved.

Both the foregoing general description and the following detailed description are exemplary and explanatory only and are not restrictive of the invention, as claimed.

### BRIEF DESCRIPTION OF DRAWINGS

The invention can be more fully understood by reading the following detailed description of the preferred embodiment, with reference made to the accompanying drawings.

FIG. 1 shows a conventional apparatus of chemical solution coating;

FIG. 2 shows a chemical solution coating apparatus provided by the invention; and

FIG. 3 illustrates the structure of the spray apparatuses of the chemical solution coating apparatus as shown in FIG. 2.

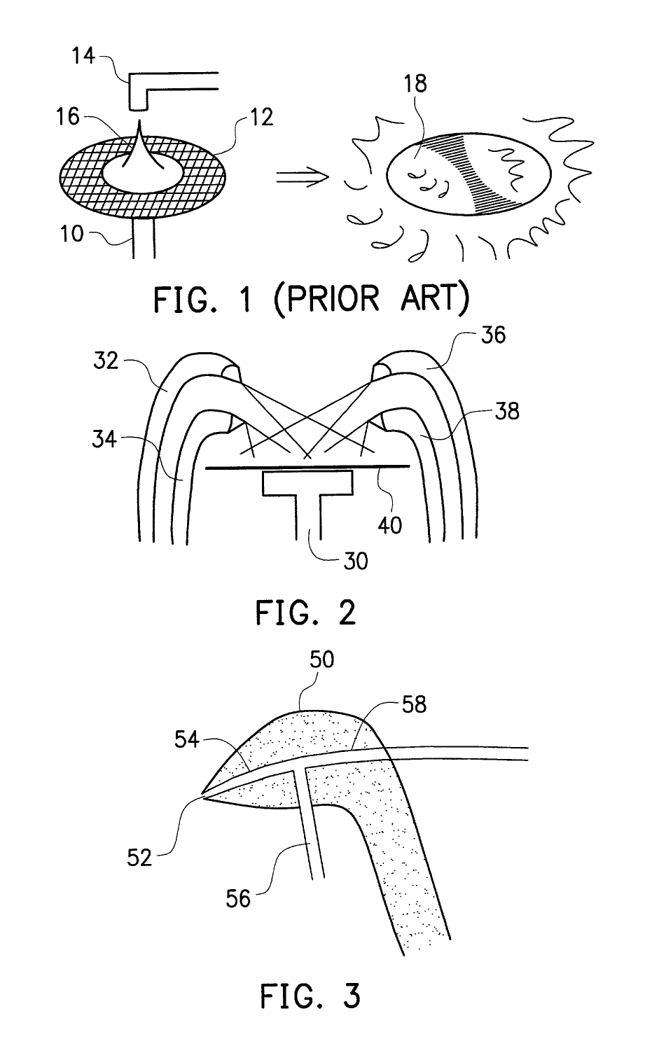

### PREFERRED EMBODIMENT

As mentioned above, the conventional apparatus uses a spinning method to provide a photoresist solution on a wafer. Under the influence of the spinning force, the photoresist solution is evenly spread on the wafer. However, due to the high spinning speed, most of the photoresist solution is spread out of the wafer. This causes a waste in material and a great cost for processing the remaining photoresist solution. Therefore, to reduce the waste in material and to save the high cost in processing, the invention provides a novel chemical solution coating apparatus as described as follows.

Referring to FIG. 2, an embodiment of the chemical solution coating apparatus is illustrated. The chemical solution applied to this invention is not restricted to a photoresist solution. As shown in FIG. 2, the chemical solution coating apparatus comprises a carrier board 30 and a plurality of spray apparatuses 32, 34, 36 and 38. On the carrier board 30, a wafer 40 to be coated with a thin film is disposed. Unlike the conventional apparatus, the carrier board 30 does not need to spin during coating. It can be stationary to achieve the evenly distribution effect of the chemical solution. However, it is appreciated that the carrier board can still be spinning with a certain speed to enhance the uniformity of the distribution of the chemical solution on the wafer under the condition that the chemical solution is not spilt out of the wafer 40. The spray apparatuses 32 to 38 are located around the carrier board 30 to spray the chemical solution on the wafer 40. By adjusting the outlets and angles of the spray apparatuses 32-38, a uniform distribution of the chemical solution on the wafer can be achieved.

FIG. 3 shows a detailed structure of each of the spray apparatuses 32 to 38. In FIG. 3, the spray apparatus comprises a spray nozzle 52 from which the chemical solution is sprayed on the wafer, and a conduit 54 as a path of the chemical solution supplied from the tube 56. The conduit 54 is also connected to a high air pressure providing tube 58. The air pressure comprises, for example, a nitrogen pressure. Under the influence of the high air pressure provided by the high air pressure providing tube 58, the chemical solution can be uniformly sprayed on the wafer 40. In FIG. 3, the conduit 54, the high air pressure providing tube 58 and the chemical solution supply tube 56 are arranged in a T-shape. The spray nozzle 52 is an outlet of the conduit 54, and the high air pressure providing conduit 58 and the chemical solution supply tube 56 are connected to an inlet of the conduit 54.

Thus constructed, the chemical solution is provided by a spray method on the wafer, so that the wafer carrier (the carrier board) does not need to spin to obtain a uniform coating provided that the positions and angles of the nozzles are well adjusted. Therefore, the waste in material and the high cost of post processing the chemical solution can be saved. Furthermore, the coating time is faster than using the conventional apparatus.

Therefore, the invention provides a chemical solution coating apparatus that provides a way to uniformly coat a chemical solution on a wafer with much reduced processing time and fabrication cost.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A chemical solution coating apparatus, comprising:
a carrier board, to carry a wafer thereon; and
a plurality of spray apparatuses, to uniformly distribute a chemical solution on the wafer by spraying.

2. The apparatus according to claim 1, wherein each of the spray apparatuses further comprises a spray nozzle from which the chemical solution is sprayed under the influence of a high air pressure.

3. The apparatus according to claim 2, wherein the high air pressure is provided by a nitrogen.

4. The apparatus according to claim 1, wherein each of the spray apparatus further comprises a high air pressure providing conduit.

5. The apparatus according to claim 1, wherein each of the spray apparatus further comprises a conduit as a path of the chemical solution.

6. The apparatus according to claim 1, wherein the chemical solution comprises a photoresist solution.

7. A chemical solution coating apparatus, comprising:
a carrier board, to carry a wafer thereon;
a plurality of spray apparatuses, to uniformly distribute a chemical solution on the wafer by spraying, each of the spray apparatuses further comprising:
a spray nozzle, from which the chemical solution is sprayed;
a conduit, with an outlet connected to the spray nozzle;
a chemical solution providing tube, connected to an inlet of the conduit; and
a high air pressure providing conduit, connected to the inlet of the conduit.

8. The apparatus according to claim 4, wherein the chemical solution comprises a photoresist solution.

9. The apparatus according to claim 4, wherein the high air pressure providing conduit provides a nitrogen pressure to the conduit.
